(19) United States
(12) Patent Application Publication
(10) Pub. No.: US 2002/0137526 A1
(43) Pub. Date: Sep. 26, 2002

(54) Positional information retrieval method and mobile telephone system

(76) Inventor: Masahito Shinohara, Tokyo (JP)

Correspondence Address: McGinn & Gibb, PLLC, Suite 200, 8321 Old Courthouse Road, Vienna, VA, 22182-3817, US

(21) Appl. No.: 10/098,331

(22) Filed: Mar. 18, 2002

(30) Foreign Application Priority Data
Mar. 22, 2001 (JP) 2001-082714

(51) Int. Cl. H04Q 7/20

(52) U.S. Cl. 455/456; 455/457; 455/557

(57) ABSTRACT

A mobile telephone system is provided with: a mobile telephone that is equipped with both a first communication means for enabling communication with other mobile telephones, stationary telephones, and stationary terminal devices by way of a base station that is connected to a network as well as a second communication means having a standard communication distance of up to 50 meters; and a plurality of wireless communication modules each provided with positional information indicating its own position that can communicate with a mobile telephone by way of the second communication means; wherein a communication link is established between a mobile telephone and a wireless communication module that is installed in the vicinity of the mobile telephone; positional information is sent from the wireless communication module to the mobile telephone in accordance with a request from the mobile telephone without processing the positional information; and the received positional information is displayed on the mobile telephone.

### BACKGROUND OF THE INVENTION

1. Field of the Invention

The present invention relates to a method of retrieving positional information for retrieving a current position, and in particular, to a method of retrieving positional information that employs mobile telephones and to a mobile telephone system.

1. Description of the Related Art

In the prior art, a method that used GPS (Global Positioning System) to obtain latitude and longitude information was used as a positional information retrieval method for detecting a current position. Another method was provided as a service in an already-existing mobile telephone system such PHS (Personal Handy-Phone System) in which one's own position is calculated by obtaining latitude and longitude information of the base station from the ID of the base station that is currently in contact.

However, of the above-described positional information retrieval methods, the method that employs GPS cannot be used in locations that are beyond the reach of satellite radiowaves, such as inside buildings or in underground malls. The method that employs the base station ID in an already-existing mobile telephone system has the problem that the accuracy of positional detection is not high.

In the methods that employ GPS or base station ID, moreover, the obtained positional information is latitude and longitude information and is therefore difficult for ordinary users to understand. For example, when people who have arranged to meet at a particular airport are checking their locations, latitude and longitude do not give an easily understandable indication of a specific location and therefore cannot be considered to be useful as positional information.

In such cases, information can be exchanged by speaking on the mobile telephone to inform one's conversation partner that, for example, “I'm now in front of the glass pagoda of - - - airport.” If the conversation partner does not know where the glass tower is, a more specific description can be supplied to help his or her understanding, such as “I'm in front of the pagoda made of glass that is in the center of the fourth floor of the northern wing of - - - airport.”

However, since it is difficult to give a detailed explanation of one's current position if both partners in the conversation are unfamiliar with the area, a system is being sought that can more easily retrieve accurate and readily understandable positional information through the use of mobile telephones.

### SUMMARY OF THE INVENTION

It is an object of the present invention to provide a method of retrieving positions and a mobile telephone system that are capable of easily retrieving highly accurate and easily understandable positional information.

To achieve the above-described object, the mobile telephone system of the present invention is a construction that includes: a mobile telephone that is equipped with a short-distance wireless communication means having a standard communication distance of up to 50 m (for example, a wireless communication means such as infrared transmission or Bluetooth); and wireless communication modules that are each installed in stationary devices such as an automatic vending machine (ticket dispenser) or a public telephone booth and that can communicate with the short-distance wireless communication means.

The method of retrieving positional information of the present invention is a method of using a mobile telephone system to retrieve one's own or one's communication partner's position wherein, when a user wishes to get positional information: a communication link is established between a mobile telephone and a wireless communication module that is installed in the vicinity of the mobile telephone, positional.information is obtained from the wireless communication module, and the positional information is displayed.

At this time, text data that indicates the address or name of the place in which the wireless communication module is installed, image data that includes a map or stereoscopic figure indicating the location at which the wireless communication module is installed, or image data that includes a picture that shows the location at which the wireless communication module is installed are transmitted as positional information from the wireless communication module to the mobile telephone.

In this method of retrieving positions, positional information is obtained from a wireless communication module by way of a communication means having a standard communication distance of up to 50 m, whereby a user can easily retrieve his or her own position through the use of a mobile telephone. In addition, by transmitting obtained positional information to the communication partner, two communication partners can easily learn each other's locations and thus eliminate the need to verify each other's location by speech.

In particular, using text data that indicate the address or name of the location at which the wireless communication module is installed, image data including a map or stereoscopic figure that shows the location at which the wireless communication module is installed, or image data such as a picture that shows the location at which the wireless communication module is installed as the positional information can facilitate understanding of a current position.

The above and other objects, features, and advantages of the present invention will become apparent from the following description based on the accompanying drawings, which illustrate examples of preferred embodiments of the present invention.

### BRIEF DESCRIPTION OF THE DRAWINGS

FIG. 1 is a block diagram showing an example of the configuration of the mobile telephone system of the present invention.

FIG. 2 is a block diagram showing the configuration of a mobile telephone that is provided in the first embodiment of the mobile telephone system of the present invention.

FIG. 3 is a block diagram showing an example of the configuration of a wireless communication module shown in FIG. 1.

FIG. 4 is a sequence chart showing the procedure of the first embodiment of the method of retrieving positional information of the present invention.

FIG. 5 is a schematic view of an example of the positional information that is displayed on the display device of the mobile telephone shown in FIG. 2.

FIG. 6 is a sequence chart showing the procedure of the second embodiment of the method of retrieving positional information of the present invention.

FIG. 7 is a schematic view of an example of a positional information list that is displayed on the display device of the mobile telephone shown information FIG. 2.

FIG. 8 is a schematic view showing an example of a map that is positional information that is displayed on the display device of the mobile telephone shown in FIG. 2.

FIG. 9 is a block diagram showing the configuration of a mobile telephone that is provided in the third embodiment of the mobile telephone system of the present invention.

FIG. 10 is a schematic view showing an example of a stereoscopic figure that is that positional information that is displayed in the display device of the mobile telephone shown in FIG. 2.

FIG. 11 is a block diagram showing the configuration of a mobile telephone that is provided in the fourth embodiment of the mobile telephone system of the present invention.

### DETAILED DESCRIPTION OF THE PREFERRED EMBODIMENTS

The present invention is next described with reference to the accompanying figures.

The method of retrieving positional information of the present invention is a method of retrieving one's own position or the position of a communication partner using a mobile telephone system. A mobile telephone is equipped with a short-distance wireless communication means (for example, an infrared transmission or Bluetooth wireless communication means) having a standard communication distance of up to 50 m to obtain positional information from a wireless communication module that is installed in a stationary device such as an automatic vending machine (ticket dispenser) or a public telephone booth and that can communicate with the short-distance wireless communication means.

First Embodiment

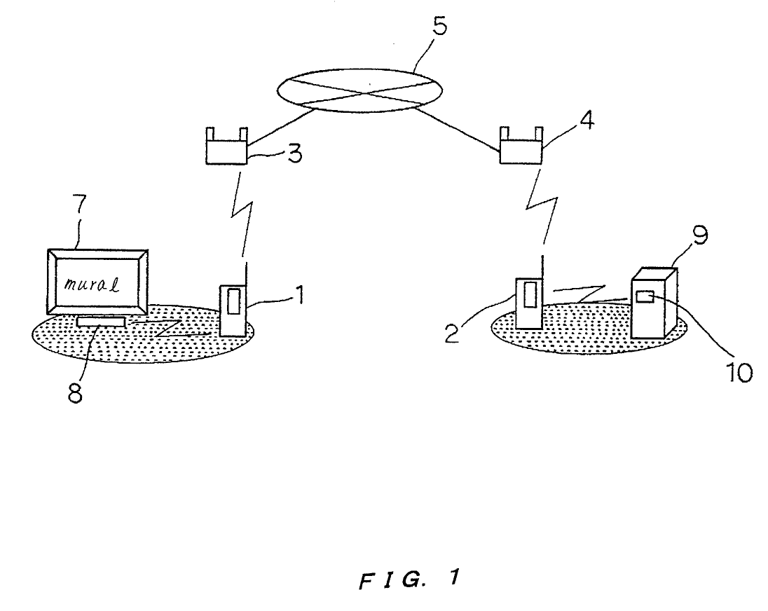

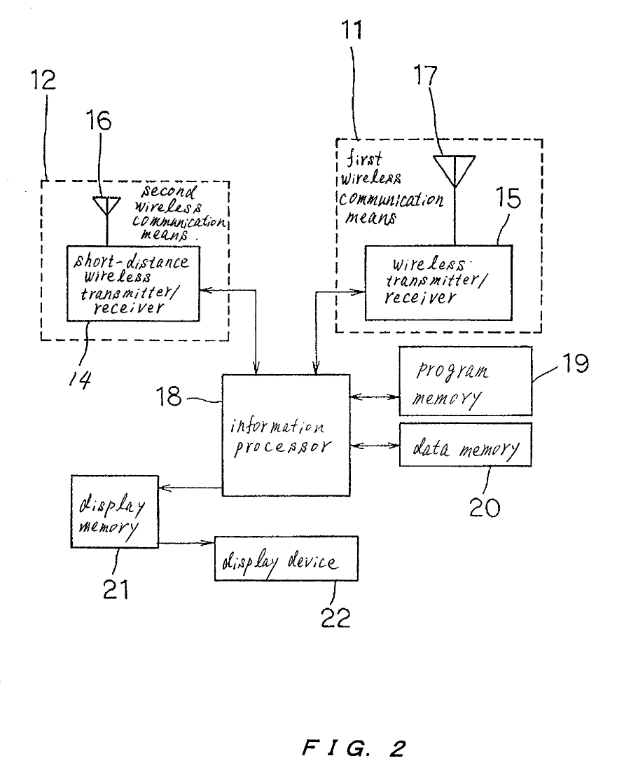

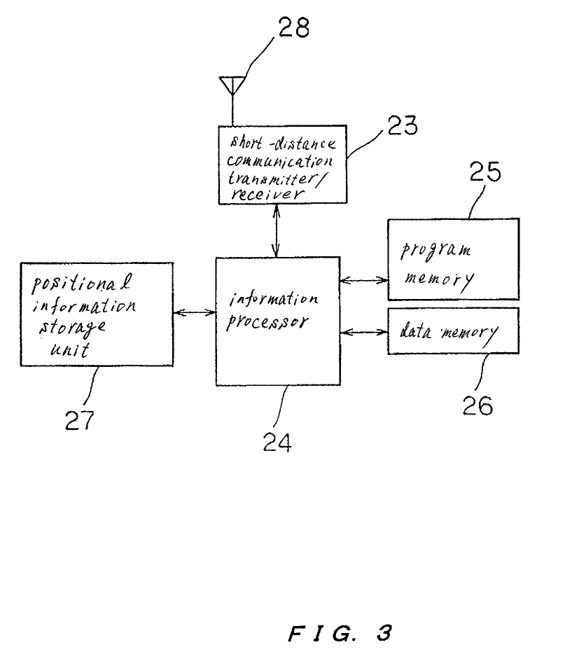

We now refer to FIG. 1, which is a block diagram showing an example of the configuration of the mobile telephone system of the present invention. FIG. 2 is a block diagram showing the configuration of a mobile telephone and shows the first embodiment of the mobile telephone system of the present invention. FIG. 3 is a block diagram showing an example of the configuration of the wireless communication module shown in FIG. 1.

As shown in FIG. 1, the mobile telephone system of the present invention includes: mobile telephones 1 and 2, and base stations 3 and 4 that realize wireless communication with mobile telephones 1 and 2; and base stations 3 and 4 are each constructions that are connected to network 5 and that enable communication and data communication with mobile telephones 1 and 2.

In addition to a first wireless communication means for realizing wireless communication with base stations 3 and 4, mobile telephones 1 and 2 are each equipped with a second wireless communication means for realizing short-distance wireless communication up to a distance of approximately 50 meters. In the example shown in FIG. 1, the second wireless communication means enables wireless communication between mobile telephone 1 and wireless communication module 8 that is installed next to mural 7 and enables wireless communication between mobile telephone 2 and wireless communication module 10 that is installed in automatic ticket dispenser 9. The second wireless communication means is preferably a device having a standard communication distance of up to 50 meters (for example, infrared transmission or Bluetooth), although the distance in which wireless communication is possible varies somewhat according to the surrounding environment.

As shown in FIG. 2, as first wireless communication means 11, mobile telephones 1 and 2 of the present embodiment are each equipped with wireless transmitter/receiver 15 for modulation/demodulation and first antenna 17 for realizing wireless communication with base stations 3 and 4. In addition, as second wireless communication means 12, mobile telephones 1 and 2 are each equipped with short-distance wireless transmitter/receiver 14 for realizing modulation/demodulation and second antenna 16 for realizing short-distance wireless communication up to a distance of approximately 50 meters. Mobile telephones 1 and 2 are constructions that are each further equipped with: information processor 18 such as a CPU for executing prescribed procedures in accordance with a program; display device 22 for displaying the processing results of information processor 18; display memory 21 for temporarily holding image data that are displayed on display device 22; program memory 19 for storing a program for realizing control of wireless communication, control of display device 22, or for analyzing information that is obtained by communication; and data memory 20 for storing positional information or other user data that are obtained from, for example, a wireless communication module.

As shown in FIG. 3, wireless communication modules 8 and 10 are constructions that each include: antenna 28 and short-distance communication transmitter/receiver 23 for modulation/demodulation for realizing short-distance wireless communication with second wireless communication means 12 of mobile telephones 1 and 2; information processor 24 that is equipped with, for example, a CPU, for executing prescribed procedures in accordance with a program; program memory 25 for storing a program for effecting control of wireless communication or information analysis of wireless data; data memory 26 for holding data that are necessary for the processing of information processor 24; and positional information storage unit 27 for saving positional information of a stationary device in which a wireless communication module is installed.

The method of retrieving positional information of the present embodiment in this configuration is next explained with reference to the figures. In the following explanation, a case is described in which the user of mobile telephone 1 retrieves his or her own position and transmits this positional information to the user of mobile telephone 2.

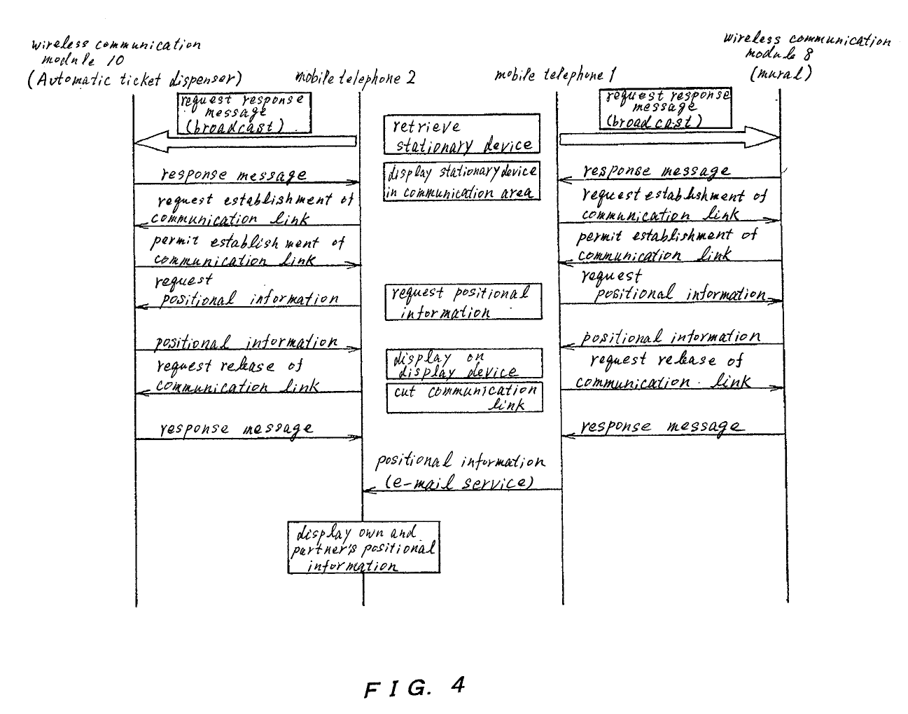

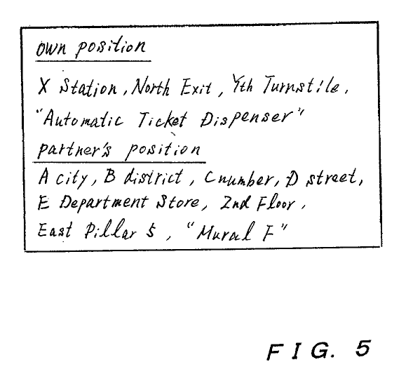

FIG. 4 is a sequence chart showing the procedure of the first embodiment of the positional information retrieval method of the present invention, and FIG. 5 is a schematic view showing an example of the positional information that is displayed on the display device of the mobile telephone shown in FIG. 2.

Referring now to FIG. 4, upon input of instructions from the user to mobile telephone 1 to retrieve positional information, mobile telephone 1 first generates a “request response” message by means of information processor 18 in accordance with a processing program that is stored in program memory 19 and broadcasts the generated “request response” message by way of second wireless communication means 12.

The “request response” message is for the purpose of detecting whether a wireless communication module that can communicate is present in the vicinity of mobile telephone 1. In the case of mobile telephone 1 shown in FIG. 1, wireless communication module 8 that is installed at mural 7 is present within communicable range, and the “request response” message that is broadcast from mobile telephone 1 is therefore received by wireless communication module 8.

Wireless communication module 8 analyzes the received message by means of information processor 24 in accordance with a processing program that is stored in program memory 25. When wireless communication module 8 verifies that the received message is a “request response” message from mobile telephone 1, it generates a response message for the “request response” message and sends the response message to mobile telephone 1.

In mobile telephone 1, the response message that has been received by second wireless communication means 12 is analyzed by means of information processor 18 and verified to be a response message from wireless communication module 8. In this case, information processor 18 recognizes that wireless communication module 8 that can communicate is present in the vicinity.

Mobile telephone 1 next generates a “request establishment of communication link” message by means of information processor 18 to establish a communication link with wireless communication module 8, and transmits the message to wireless communication module 8 by way of second wireless communication means 12.

Wireless communication module 8 analyzes the received message by means of information processor 24. After verifying that the received message is a “request establishment of communication link” message from mobile telephone 1, wireless communication module 8 next generates a “permit establishment of communication link” message and transmits the message to mobile telephone 1.

When the communication link between mobile telephone 1 and wireless communication module 8 has been established, mobile telephone 1 generates a “request positional information” message by means of information processor 18 for obtaining positional information from wireless communication module 8 and transmits the message to wireless communication module 8 by way of second wireless communication means 12.

Wireless communication module 8 analyzes the received message by means of information processor 24, and upon verification that the message is a “request positional information” message from mobile telephone 1, reads its own positional information that is stored in positional information storage unit 27 and transmits the read positional information to mobile telephone 1 without alteration.

Information that includes an easily understood “address” or “name” of a location such as “A city, B district, C number, D street, E Department Store, 2nd Floor, East Pillar 5” or “Mural F” is stored in positional information storage unit 27 of wireless communication module 8. Establishing positional information in this form allows a user to easily understand the current position.

When mobile telephone 1 receives the positional information from wireless communication module 8 by means of second wireless communication means 12, the positional information is converted to a prescribed data format, stored in display memory 21, and displayed on display device 22.

To be precise, the positional information of the device that is displayed on mobile telephone 1 is the position of mural 7. However, since this positional information indicates a position that is within a short distance of 50 meters or less (the communication range), using this position as the position of the mobile telephone 1 presents no particular problem.

After the positional information has been obtained, mobile telephone 1 generates by means of information processor 18 a “request release of communication link” message to cut the communication link with wireless communication module 8 in accordance with key-input instructions from the user, and transmits the message to wireless communication module 8 by way of second wireless communication means 12. Upon receiving the “request release of communication link” message from mobile telephone 1, wireless communication module 8 generates by means of information processor 24 a response message and both transmits the message to mobile telephone 1 and cuts the communication link with mobile telephone 1.

Similarly, mobile telephone 2 uses second wireless communication means 12 to communicate with wireless communication module 10 of automatic ticket dispenser 9 that is in the vicinity to obtain positional information from wireless communication module 10. The positional information that is obtained by mobile telephone 2 is, for example, “X Station, North Exit, Yth Turnstile” and “Automatic Ticket Dispenser.”

Positional information of each of the devices of mobile telephones 1 and 2 can be obtained by the above-described procedures.

When positional information is to be reported from mobile telephone 1 to mobile telephone 2, the information may be transmitted to the communication partner by means of an already-existing short message service or e-mail service. In this case, mobile telephone 1 establishes a communication link with base station 3 and transmits to base station 3 the positional information that has been obtained from wireless communication module 8 by way of first wireless communication means 11.

Base station 3 transfers data that have been sent from mobile telephone 1 to base station 4 by way of network 5, base station 4 being the base station of the communication area in which mobile telephone 2 of the communication partner is situated, and base station 4 transmits the data to mobile telephone 2.

Mobile telephone 2 stores each item of positional information that has been transmitted from mobile telephone 1 and its own positional information in display memory 21 and displays the information on display device 22. Performing this process brings about the display of the position mobile telephone 2 and the location of the communication partner on display device 22 of mobile telephone 2, for example, as shown in FIG. 5.

Obtaining positional information in a mobile telephone from a wireless communication module by way of second wireless communication means 12 having a standard communication distance of up to 50 meters as described in the foregoing explanation enables a user to easily retrieve his or here own position through the use of a mobile telephone. In addition, transmitting the obtained positional information to a communication partner enables both communication partners to easily learn each other's current locations and eliminates the need to verify each other's locations by speech.

Second Embodiment

In the second embodiment, a procedure is shown for a case in which response messages from a plurality of wireless communication modules are sent back in response to a “request response” message that is broadcast from mobile telephone 1. In addition, the positional information that is provided by the wireless communication module of this embodiment includes image data such as a map or a picture rather than text data such as an address or a name. The configuration of the mobile telephone system, mobile telephones, and wireless communication modules in this embodiment is identical to that of the first embodiment and redundant explanation is therefore omitted.

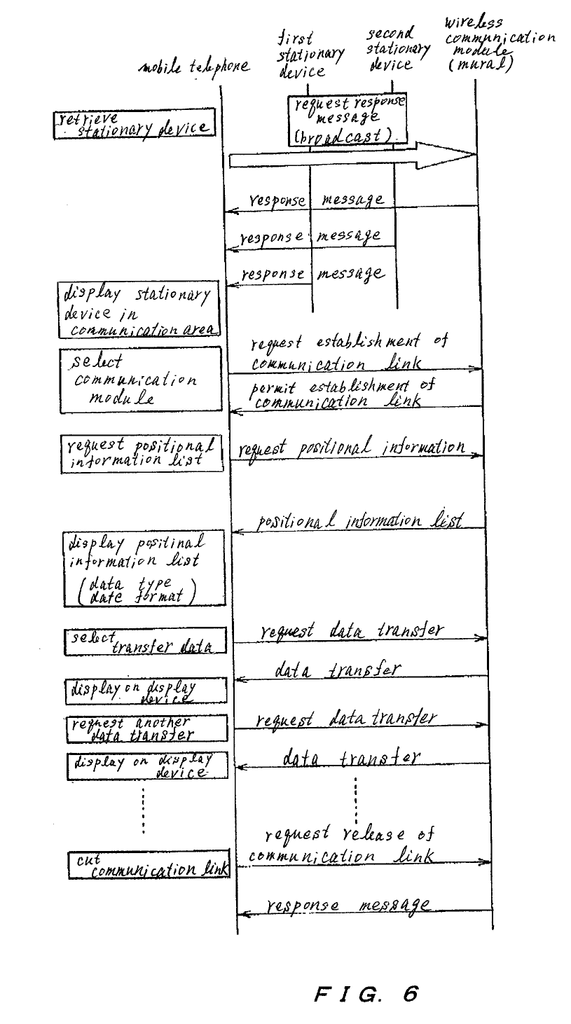

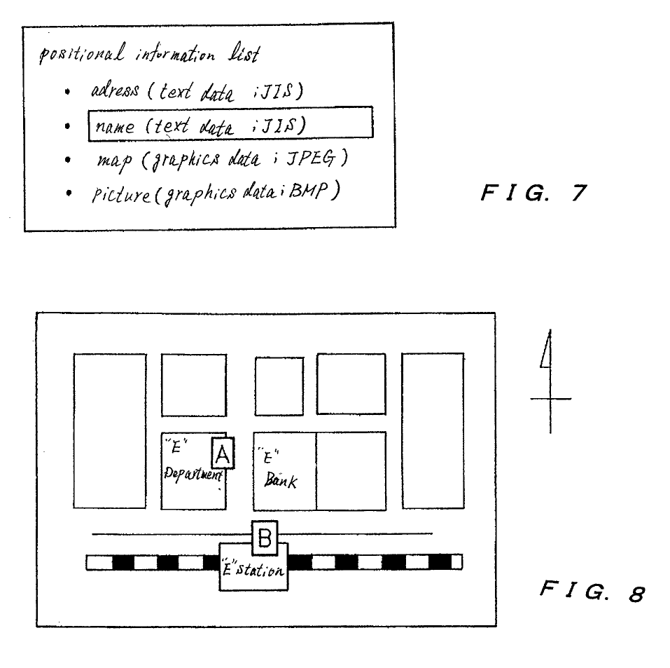

FIG. 6 is a sequence chart showing the procedure of the second embodiment of the method of retrieving positional information of the present invention, and FIG. 7 is a schematic view showing an example of a positional information list that is displayed on the display device of the mobile telephone shown in FIG. 2.

Referring now to FIG. 6, when an instruction to retrieve positional information is applied as input from a user to mobile telephone 1, mobile telephone 1 first generates a “request response” message by means of information processor 18 in accordance with a processing program that is stored in program memory 19 and broadcasts the generated “request response” message by way of second wireless communication means 12.

In this embodiment, as with the first embodiment, a case is described in which positional information is obtained from wireless communication module 8 that is installed next to mural 7 shown in FIG. 1. In this case, however, not only wireless communication module 8, but wireless communication modules of the same construction as wireless communication module 8 that are installed in a first stationary device and a second stationary device not shown in the figure are present within the communication area of mobile telephone 1.

In this case, the “request response” message that is broadcast from mobile telephone 1 is received by wireless communication module 8 that is installed next to mural 7, the wireless communication module that is installed in the first stationary device, and the wireless communication module that is installed in the second stationary device.

Each of the wireless communication modules analyzes the received message by means of information processor 24, and upon verifying that the received message is a “request response” message from a mobile telephone, generates a response message to the “request response” message and transmits the response message to mobile telephone 1. At this time, it is assumed that the response message includes ID information for specifying the stationary device that is the transmission source or information indicating the category of the stationary device. In FIG. 6, an example is shown in which the response from wireless communication module 8 that is installed in mural 7 arrives last, but the order of responses from the wireless communication modules is not fixed to this order.

After having received the response messages from each of the wireless communication modules, mobile telephone 1 uses information processor 18 to extract the ID information of the stationary device or the information indicating the category of the stationary device from each of the response messages and displays the information on display device 22.

The user operates the keyboard of mobile telephone 1 in accordance with instructions that are displayed on display device 22 and selects the stationary device from which positional information is to be obtained.

When the user has selected a stationary device, mobile telephone 1 generates a “request positional information list” message by means of information processor 18 and transmits the “request positional information list” message to the wireless communication module that is installed in the selected stationary device by way of second wireless communication means 12. In this case, the “request positional information list” message is transmitted to wireless communication module 8 that is installed in mural 7 as described in the foregoing explanation.

After having received the “request positional information list” message from mobile telephone 1, wireless communication module 8 transmits to mobile telephone 1 the amount of data, the data type, and the data format of the positional information as the positional information list that is stored in positional information storage unit 27.

In this case, the data type is information indicating the type of data such as, for example, text data or graphics (image) data. The data format is information indicating the form of data such as Unicode and JIS (Japanese Industrial Standards) kanji code (in the case of text data) or JPEG, GIF, and BMP (in the case of graphics data).

Taking into consideration its own processing capability or the programs that it holds, mobile telephone 1 uses information processor 18 to generate, from the positional information list that has been received from the wireless communication module, a list of obtainable positional information such as shown in FIG. 7 and displays the list on display device 22.

As examples, “address” that is displayed in the positional information list is “A city, B district, C number, D street, E Department Store, 2nd Floor, East Pillar 5”; “name” is “In front of the Hachiko statue at Shibuya Station”; “map” is a figure such as shown in FIG. 8; and “picture” shows the scene of a location that includes the user that owns the mobile telephone. However, the availability of “picture” is limited to cases in which a camera is connected to the stationary device in which wireless communication module 8 is installed.

The user operates the keyboard of mobile telephone 1 in accordance with instructions that are displayed on display device 22 to select the desired positional information (data).

When the user has selected data, mobile telephone 1 generates a “request data transfer” message by means of information processor 18 to request the selected data and transmits the message to wireless communication module 8 by way of second wireless communication means 12.

Wireless communication module 8 reads the requested positional information (data) from positional information storage unit 27 in accordance with the “request data transfer” message that has been sent from the mobile telephone and sends the data to mobile telephone 1.

Mobile telephone 1 converts the data that is received by second wireless communication means 12 to a prescribed format by means of information processor 18 and displays the data on display device 22.

The user checks the data that are displayed on mobile telephone 1, and if necessary, uses mobile telephone 1 to request data of another format. In this case, the positional information that the user considers best is sent to the communication partner.

If the desired positional information has been obtained, mobile telephone 1 generates, in accordance with key-input instructions from the user, a “request release of communication link” message for cutting the communication link with wireless communication module 8 by means of information processor 18 and transmits the message to wireless communication module 8 by way of second wireless communication means 12. After receiving the “request release of communication link” message from mobile telephone 1, wireless communication module 8 generates, by means of information processor 24, a response message and then both sends the message to mobile telephone 1 and cuts the communication link with mobile telephone 1.

Then, as with the first embodiment, an already-existing short message service or e-mail service is used to send the positional information to mobile telephone 2 of the communication partner.

As with the first embodiment, the above-described second embodiment of the method of retrieving positional information enables a user to easily retrieve his or her own location using a mobile telephone.

Third Embodiment

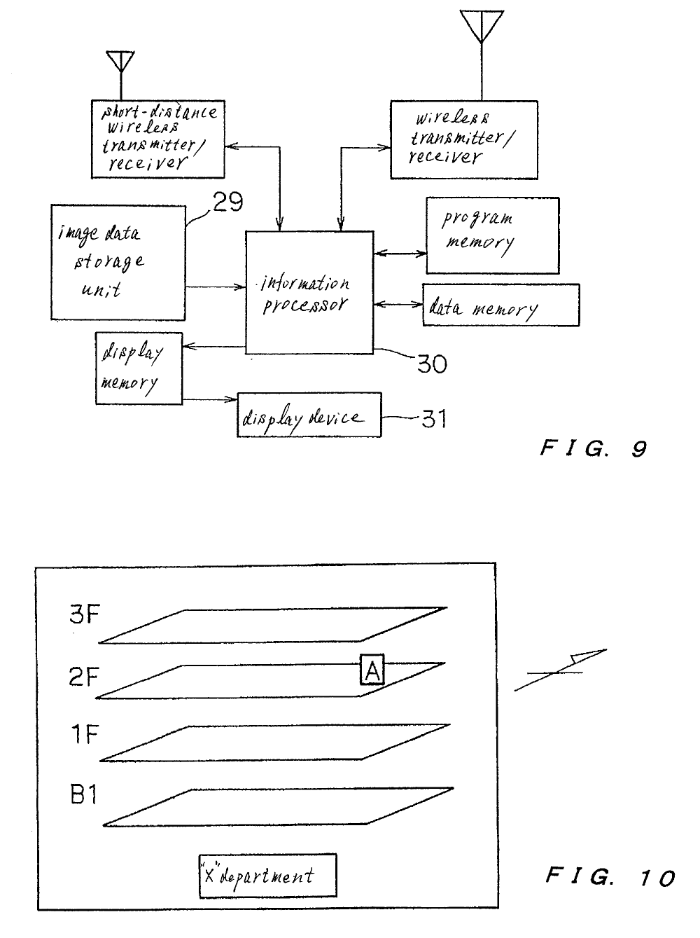

FIG. 9 shows the third embodiment of the mobile telephone system of the present invention, and is a block diagram showing the configuration of a mobile telephone.

As shown in FIG. 9, the third embodiment differs from the first embodiment in that the mobile telephone is provided with image data storage unit 29 for storing map data or building data. The constitution of the mobile telephone is otherwise identical to that of the first embodiment, and redundant explanation is therefore omitted. The constitution of the mobile telephone system and wireless communication module is also identical to that of the first embodiment, and redundant explanation is therefore omitted.

By means of information processor 30, the mobile telephone of this embodiment combines the map data or building data that are stored in image data storage unit 29 with its own positional information and the positional information of the communication partner that have been retrieved by the same procedure as in the first embodiment, and displays the result.

As an example, information processor 30 overlays the positional information that has been obtained from wireless communication module 8 on map data that are stored in image data storage unit 29 and displays a map such as shown in FIG. 8 on display device 31. Point A in FIG. 8 indicates the position of mobile telephone 1, and Point B indicates the position of mobile telephone 2.

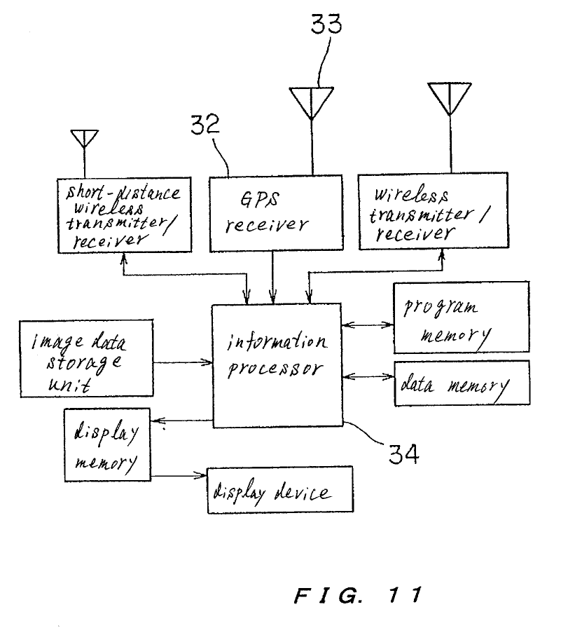

Alternatively, the positional information that has been obtained from wireless communication module 8 is superposed on the building data that are stored in image data storage unit 29, and the position of mobile telephone 1 or mobile telephone 2 of the communication partner is stereoscopically displayed on display device 31 as shown in, for example, FIG. 10. In FIG. 10, the building configuration of “X” department store is shown stereoscopically, and the position of mobile telephone 1 is indicated by Point A. Image data in which positional information has been superposed on building data in this way may be stored in positional information storage unit of the wireless communication module that was described in the second embodiment.

As described in the foregoing explanation, the provision, by a mobile telephone, of positional information using a map or stereoscopic positional information that did not exist in the prior art enables the provision of more easily understandable positional information.

Fourth Embodiment

FIG. 11 shows the fourth embodiment of the mobile telephone system of the present invention and is a block diagram showing the configuration of a mobile telephone.

As shown in FIG. 11, the present embodiment differs from the first embodiment in that the mobile telephones are provided with GPS antenna 33 and GPS receiver 32 for receiving radiowaves from a GPS satellite as a position retrieval means by means of GPS.

Information processor 34 can selectively use positional information that is obtained by a positional information retrieval method that is similar to that of the first embodiment, positional information that is obtained by GPS, or positional information that is obtained by using the ID of the base station of the prior art.

The composition of the mobile telephone is otherwise identical to that of the first embodiment, and redundant explanation is therefore omitted. Further, the constitution of the mobile telephone system and the wireless communication module is also identical to that of the first embodiment and redundant explanation of these elements is therefore here omitted.

The adoption of this constitution allows positional information to be obtained by means of GPS or the base station ID when, for example, positional information cannot be obtained by the mobile telephone system of the first embodiment.

The foregoing explanation assumes a case in which positional information is exchanged between mobile telephones, but the same service can be provided when positional information is exchanged between a mobile telephone and a stationary telephone or a stationary terminal device such as a personal computer that is connected to the Internet. In such a case, positional information that has been obtained by the mobile telephone may be sent to the stationary telephone or personal computer as text data, graphics data, or, if necessary, speech data.

In addition, a call may be originated from one mobile telephone to another mobile telephone and a prescribed command may be sent from the mobile telephone that originated the call to cause the other mobile telephone to obtain its own positional information and send back this positional information, whereby the position of a communication partner can be learned even when a call is not ongoing.

Finally, the positional information is not limited to the cases described in the examples and may be of any easily understandable form.

While preferred embodiments of the present invention have been described using specific terms, such description is for illustrative purposes only, and it is to be understood that changes and variations may be made without departing from the spirit or scope of the following claims.

What is claimed is:

1. A method of retrieving positional information by using a mobile telephone system comprising:
a mobile telephone that is equipped with:
a first communication means for enabling communication, by way of a base station that is connected to a network, with other mobile telephones, stationary telephones, and stationary terminal devices; and
a second communication means having a standard communication distance of up to 50 m; and
a plurality of wireless communication modules that are each equipped with positional information indicating the location of its own device and that can communicate with said mobile telephone by way of said second communication means;
said method comprising the steps of:
establishing a communication link between a said mobile telephone and a said wireless communication module that is installed in the vicinity of the mobile telephone;
sending said positional information from said wireless communication module to said mobile telephone in accordance with a request from the mobile telephone without processing said positional information; and
displaying said positional information on said mobile telephone.

2. The method of retrieving positional information according to claim 1, wherein said positional information is text data that show the address or the name of the place in which said wireless communication module is installed.

3. The method of retrieving positional information according to claim 1, wherein said positional information is image data that include a map or stereoscopic view of the place in which said wireless communication module is installed.

4. The method of retrieving positional information according to claim 1, wherein said positional information is image data that include a picture that shows the place in which said wireless communication module is installed.

5. The method of retrieving positional information according to claim 1, wherein:
said mobile telephone is equipped in advance with image data for showing a map or stereoscopic view of a building; and
said positional information that have been provided from said wireless communication module is combined with the image data and then displayed.

6. The method of retrieving positional information according to claim 1, wherein
said mobile telephone is provided in advance with at least one of a GPS position retrieval means for obtaining positional information by GPS and a base station position retrieval means for obtaining positional information of said base station from the ID of the base station; and
positional information of said wireless communication module, positional information that is obtained by said GPS position retrieval means, and positional information that is obtained by said base station position retrieval means can be selectively displayed.

7. A mobile telephone system, comprising:
a mobile telephone that is equipped with:
a first communication means for enabling communication, by way of a base station that is connected to a network, with other mobile telephones, stationary telephones, and stationary terminal devices; and
a second communication means having a standard communication distance of up to 50 m;
wherein said mobile telephone displays positional information that has been obtained by way of the second communication means; and
a plurality of wireless communication modules that are each equipped with positional information indicating the location of its own device and that can communicate with said mobile telephone by way of said second communication means for providing the positional information without processing in accordance with a request from said mobile telephone.

8. The mobile telephone system according to claim 7, wherein said positional information is text data that show the address or the name of the place in which said wireless communication module is installed.

9. The mobile telephone system according to claim 7, wherein said positional information is image data that include a map or stereoscopic view of the place in which said wireless communication module is installed.

10. The mobile telephone system according to claim 7, wherein said positional information is image data that include a picture that shows the place in which said wireless communication module is installed.

11. The mobile telephone system according to claim 7, wherein:
said mobile telephone is equipped in advance with image data for showing a map or stereoscopic view of a building; and
said positional information that have been provided from said wireless communication module is combined with the image data and then displayed.

12. The mobile telephone system according to claim 7, wherein:
said mobile telephone is provided with at least one of a GPS position retrieval means for obtaining positional information by GPS and a base station position retrieval means for obtaining positional information of said base station from the ID of said base station; and
positional information of said wireless communication module, positional information that is obtained by said GPS position retrieval means, and positional information that is obtained by said base station position retrieval means can be selectively displayed.

13. A mobile telephone comprising:
a first communication means for enabling communication, by way of a base station that is connected to a network, with other mobile telephones, stationary telephones, and stationary terminal devices;
a second communication means having a standard communication distance of up to 50 m;
a display device for displaying positional information that is obtained by way of said second communication means; and
an information processor for displaying on said display device positional information that has been obtained by way of said second communication means without processing.

14. The mobile telephone according to claim 13, wherein:
said mobile telephone further comprises an image data storage unit for storing image data that show a map or a stereoscopic structure of a building; and
said information processor combines said positional information that has been obtained by way of said second communication means with the image data and displays the result on said display device.

15. The mobile telephone according to claim 13, wherein:
said mobile telephone is provided with at least one of a GPS position retrieval means for obtaining positional information by GPS and a base station position retrieval means for obtaining positional information of said base station from the ID of said base station; and
said information processor can selectively display on said display device positional information of said wireless communication module, positional information that is obtained by said GPS position retrieval means, and positional information that is obtained by said base station position retrieval means.

16. A wireless communication module comprising:
a communication means having a standard communication distance of up to 50 m for enabling wireless communication with a mobile telephone;
a positional information storage unit for storing positional information that indicate the location of the wireless communication module; and
an information processor for performing processing to provide the positional information in accordance with a request from said mobile telephone without processing said positional information.

17. The wireless communication module according to claim 16, wherein said positional information is text data that show the address or the name of the place in which said wireless communication module is installed.

18. The wireless communication module according to claim 16, wherein said positional information is image data that include a map or stereoscopic view of the place in which said wireless communication module is installed.

19. The wireless communication module according to claim 16, wherein said positional information is image data that include a picture that shows the place in which said wireless communication module is installed.
